(19) United States
(12) Patent Application Publication
(10) Pub. No.: US 2016/0364096 A1
(43) Pub. Date: Dec. 15, 2016

(54) DISPLAY APPARATUS AND CONTROL METHOD THEREOF

(71) Applicant: SAMSUNG ELECTRONICS CO., LTD., Suwon-si (KR)

(72) Inventors: Seung-min SHIN, Seoul (KR); Sung-pil HWANG, Suwon-si (KR); Seung-won KIM, Seoul (KR); Je-youn DONG, Suwon-si (KR)

(73) Assignee: SAMSUNG ELECTRONICS CO., LTD., Suwon-si (KR)

(21) Appl. No.: 15/179,214

(22) Filed: Jun. 10, 2016

(30) Foreign Application Priority Data
Jun. 10, 2015 (KR) 10-2015-0081850

(51) Int. Cl. G06F 3/0482; G06F 3/0486

(52) U.S. Cl. CPC G06F 3/0482; G06F 3/0486

(57) ABSTRACT

A display apparatus, including a display; an interface configured to connect to an external device; a storage; and a controller configured to: while connected with the external device, control the display to display a first graphical user interface (GUI) comprising a plurality of menu items corresponding to a plurality of functions, and perform a function corresponding to a menu item selected by a user from among the plurality of menu items, control the storage to store history information comprising information associated with the menu item and information on the external device connected through the interface when the menu item is selected, and in response to receiving a request for a GUI, control the display to display a second GUI comprising at least one menu item selected based on the history information and the external device connected through the interface when the request for the GUI is received.

### CROSS-REFERENCE TO RELATED APPLICATION

This application claims priority from Korean Patent Application No. 10-2015-0081850, filed on Jun. 10, 2015 in the Korean Intellectual Property Office, the disclosure of which is incorporated herein by reference in its entirety.

### BACKGROUND

Field

Apparatuses and methods consistent with the exemplary embodiments relate to a display apparatus and control method thereof for displaying a user's preferred function, and more particularly to a display apparatus and a control method thereof for determining a user's preferred function according to an external device connected to the display apparatus based on a usage history and for displaying a menu item corresponding thereto.

Description of Related Art

A display apparatus processes an image signal/image data which is transmitted by various external image sources or is stored in the display apparatus. Such display apparatus includes a display, which displays a processed image. For example, the display apparatus may be achieved by a TV or a monitor. If the display apparatus is achieved by, e.g. a TV, it performs various image processing processes such as decoding and scaling of a broadcast signal provided from the exterior and displays an image of a desired broadcasting channel in a display.

In line with development of technology and diverse demands from users, the display apparatus provides more diverse functions. However, users who use the display apparatus do not always use all of functions of the display apparatus. Rather, they use familiar functions in accordance with their usage patterns.

Since an existing display apparatus displays a plurality of preset menu items at a time, a user should perform manipulations inconveniently each time he/she searches a menu item to use a desired function from all menu items.

To solve the foregoing problem, a conventional display apparatus separately provides a user with items of functions which have been used more than other functions, attempting to improve usability of the display apparatus.

However, the conventional display apparatus merely provides a user with the item of frequently used functions by only determining the number of usage of the functions, failing to take into account a great difference in the usage pattern that takes places depending on the connected external device.

### SUMMARY

According to an aspect of an exemplary embodiment, a display apparatus includes a display; an interface configured to connect to an external device; a storage; and a controller configured to: while connected with the external device, control the display to display a first graphical user interface (GUI) comprising a plurality of menu items corresponding to a plurality of functions, and perform a function corresponding to a menu item selected by a user from among the plurality of menu items, control the storage to store history information comprising information associated with the menu item and information on the external device connected through the interface when the menu item is selected, and in response to receiving a request for a GUI, control the display to display a second GUI comprising at least one menu item selected based on the history information and the external device connected through the interface when the request for the GUI is received.

The controller, based on the history information, may be further configured to increase or decrease a preference of at least one function, determine a function having the preference greater than or equal to a first threshold to be a preferred function of the user, and control the display to display the second GUI comprising at least one menu item corresponding to the preferred function.

The controller may be configured to exclude a function having the preference equal to or less than a second threshold from the preferred function.

The controller may be further configure to additionally increase or decrease the preference of the at least one function based on a frequency of the user selecting a menu item corresponding to the at least one function.

The controller may be further configure to increase or decrease the preference of the at least one function in a manner based on whether the at least one function may include the preferred function.

The controller may be further configure to determine at least one function among the plurality of functions to be a preferred function of the user based on a function usage pattern of the user, and control the display to display a third GUI comprising at least one menu item corresponding to the preferred function based on the function usage pattern in response to the function usage pattern is being detected.

The function usage pattern may include a use of a first function of the plurality of functions, followed by a use of a second function of the plurality of functions.

The function usage pattern may include a use of at least one function within a preset time after the external device is disconnected.

The controller may be further configure to control the display to display a fourth GUI for a user to edit the preferred function.

The second GUI may be received from the connected external device.

According to another aspect of an exemplary embodiment, a control method of a display apparatus includes connecting to an external device through an interface; while connected with the external device, displaying a first graphical user interface (GUI) comprising a plurality of menu items corresponding to a plurality of functions, and performing a function corresponding to a menu item selected by a user from among the plurality of menu items; storing history information comprising information associated with the menu item and information on the external device connected through the interface when the menu item is selected; and in response to receiving a request for a GUI, displaying a second GUI comprising at least one menu item selected based on the history information and the external device connected through the interface when the request for the GUI is received.

The displaying the second GUI may include: increasing or decreasing a preference of at least one function based on the history information; determining a function having preference greater than or equal to a first threshold to be a preferred function of the user; and displaying a second GUI comprising at least one menu item corresponding to the preferred function according to the preferred function.

The displaying the second GUI may include excluding a function having preference less than or equal to a second threshold from the preferred function.

The increasing or decreasing the preference of the at least one function may include additionally increasing or decreasing the preference of the at least one function based on a frequency of the user selecting a menu item corresponding to the at least one function.

The increasing or decreasing the preference may include increasing or decreasing the preference of the at least one function in a manner based on whether the at least one function may include the preferred function.

The control method may further include determining at least one function among the plurality of functions to be a preferred function of the user based on a function usage pattern of the user; and displaying a third GUI comprising a at least one menu item corresponding to the preferred function based on the function usage pattern in response to the function usage pattern is being detected.

The function usage pattern may include a use of a first function of the plurality of functions followed by a use of a second function of the plurality of functions.

The function usage pattern may include a use of at least one function within a preset time after the external devices is disconnected.

The control method may further include displaying a fourth GUI for a user to edit the preferred function.

The displaying of the second GUI further may include receiving the second GUI from the connected external device.

### BRIEF DESCRIPTION OF THE DRAWINGS

The above and/or other aspects will become apparent and more readily appreciated from the following description of exemplary embodiments, taken in conjunction with the accompanying drawings, in which:

FIG. 1 is a block diagram of a display apparatus according to an exemplary embodiment;

FIG. 2 is a table showing data which is capable of being stored in a storage according to an exemplary embodiment;

FIG. 3 is a flowchart showing operations of the display apparatus according to an exemplary embodiment;

FIG. 4 is a flowchart showing operations of determining a user's preferred function according to an exemplary embodiment;

FIG. 5 is a flowchart showing operations of decreasing a preference of a function according to an exemplary embodiment;

FIG. 6 illustrates a graphic user interface (GUI) which is displayed by the display apparatus according to an exemplary embodiment;

FIG. 7 illustrates a GUI for editing a preferred function displayed by the display apparatus according to an exemplary embodiment;

FIG. 8 illustrates a GUI for editing a preferred function displayed by the display apparatus according to an exemplary embodiment;

FIG. 9 illustrates a GUI for editing information on an external device displayed by the display apparatus according to an exemplary embodiment;

FIG. 10 illustrates an image and function displayed by the display apparatus according to an exemplary embodiment;

FIG. 11 is a flowchart showing operations of determining and displaying a preferred function based on a usage pattern with respect to functions according to an exemplary embodiment; and

FIG. 12 is a flowchart showing operations of displaying and updating a user's preferred function according to an exemplary embodiment.

### DETAILED DESCRIPTION OF EXEMPLARY EMBODIMENTS

Below, exemplary embodiments will be described in detail with reference to accompanying drawings.

Hereinafter, a display apparatus and a control method thereof for determining a user's preferred function according to an external device connected to the display apparatus and for displaying such preferred function according to an exemplary embodiment will be described in detail.

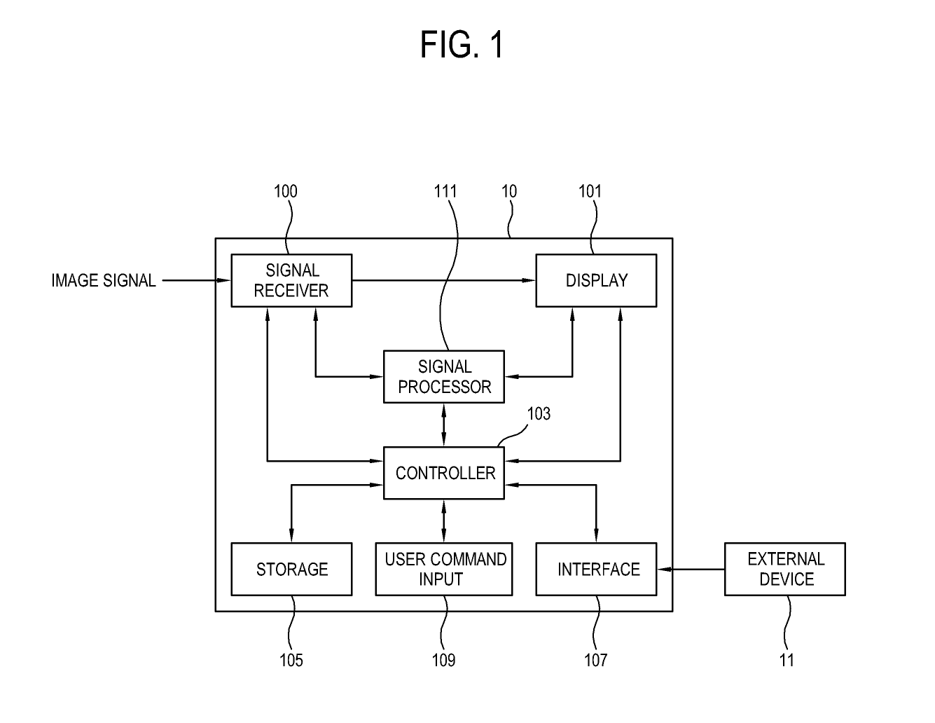

FIG. 1 is a block diagram of a display apparatus 10 according to an exemplary embodiment. The display apparatus 10 may include a signal receiver 100, a display 101, a controller 103, a storage 105, an interface 107, a user command input 109, and a signal processor 111. However, the elements of the display apparatus 10 in FIG. 1 are an exemplary embodiment, and may be different therefrom as the case may be. That is, at least one of the elements of the display apparatus 10 may be excluded therefrom or a new element may be added to the display apparatus 10 although it is not shown in FIG. 1.

The signal receiver 100 receives an image signal from the exterior. The signal receiver 100 may include a tuner to receive an image signal. The tuner may be tuned to one of a plurality of channels and may receive an image signal from such channel by control of the controller 103. The selection of the channel may be made by a user's manipulation. For example, the display apparatus 10 may further include the user command input 109 to receive a user's manipulation command. The user command input 109 may directly receive a manipulation command through a manipulation panel or receive a remote control signal including a user's manipulation command from a remote controller.

According to another exemplary embodiment, the signal receiver 100 may receive an image signal from an imaging device such as a set-top box, DVD, PC, etc., or receive an image signal from a peripheral device such as a smart phone or receive an image signal from a server through a network such as the Internet.

The signal processor 111 processes a received image signal to display an image in the display 101. The signal processor 111 may perform, e.g. modulation, demodulation, multiplexing, de-multiplexing, analog-digital conversion, digital-analog conversion, decoding, encoding, image enhancement, or scaling with respect to a received image signal. Also, the signal processor 111 may cause a graphic user interface (GUI), which includes a menu item corresponding to a plurality of functions provided by the display apparatus 10, to be displayed in the display 101 by control of the controller 103.

The display 101 displays an image based on an image signal processed by the signal processor 111. The display 101 may display an image by various methods such as LCD, PDP and OLED.

The storage 105 may store various information by control of the controller 103. Also, the storage 105 may store information on a function of the display apparatus 10. The storage 105 may be achieved by a non-volatile memory such as a flash memory or a hard disc drive. Data to be stored in the storage 105 may include history information including information on a menu item selected by a user to use a function of the display apparatus 10 and information on a time when a user selected the menu item. Also, the data to be stored in the storage 105 may include various applications for executing a function of the display apparatus 10 as well as an operating system for driving the display apparatus 10.

The interface 107 is provided to be connectable to each of a plurality of external devices 11, and may plurally include connection ports according to various specifications such as high definition multimedia interface (HDMI) and universal serial bus (USB). The interface 107 may perform communication as a communicator to be connected to the external devices 11. The interface 107 may perform wired communication with a plurality of servers through a wired local area network (LAN). The interface 107 may further perform wireless communication. In such case, the interface 107 may include a radio frequency (RF) circuit to transmit and receive an RF signal. The interface 107 may perform wireless communication through a wireless network such as wireless LAN and Wi-Fi. Otherwise, the interface 107 may perform wireless communication with the external devices 11 through Bluetooth. Further, the interface 107 may perform communication for internet telephone and message transmission and reception.

The controller 103 performs a control operation with respect to various elements of the display apparatus 10. For example, the controller 103 processes an image signal received by the signal receiver 100 and displays the processed image through the display 101. Also, the controller 103 executes a function corresponding to a menu item selected by a user's selection of the menu item, stores in the storage 105 data related to history information including information on the selected menu item and information on the time when a user selected the menu item and controls a connection operation between the interface 107 and the external devices 11. The controller 103 also analyzes the history information stored in the storage 105, and determines a user's preferred function according to the connected external device, and selects, and displays in the display 101, a menu item corresponding to a function which has been determined to be the user's preferred function.

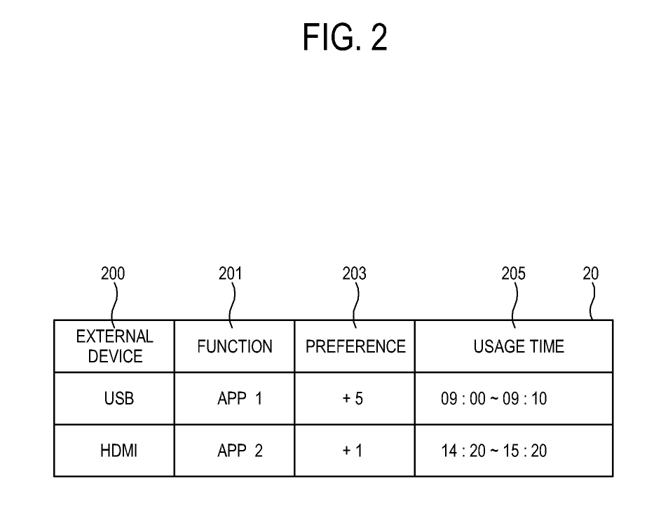

FIG. 2 illustrates a table showing history information 20 including a menu item selected by a user and information on the connected external device, as may be stored in the storage 105 according to an exemplary embodiment. If a user selects a menu item of a GUI to use a function 201 of the display apparatus 10, the controller 103 performs a function corresponding to the selected menu item. Then, history information including information on the menu item selected by a user and information on the connected external device is stored in the storage 105. Information on the function 201 used by a user and a time 205 when a user used the function 201 may also be stored in the storage 105. The information may include items relating to the connected external device 200, the function 201, a preference 203 and the time 205. The foregoing information items are just examples, and the stored information item is not limited to those shown in FIG. 2.

The external device 200 is connected to the display apparatus 10 through the interface 107, and may include all of external devices 200 that may be connected to the display apparatus 10 through USB, HDMI, LAN, etc. Since with respect to the same function 201, the preference 203 may vary depending on the connected external device 200, a user's preferred function may not be identical per the external device 200. The name of the external device 200 is set in advance, but a GUI may be provided to a user for edition. This will be described later.

According to another exemplary embodiment, the display apparatus 10 may access one of a plurality of sources through a communicator. The sources are physical or virtual objects that may provide various data as well as videos and images. As an example, the sources may be a domain in the Internet. The domain is for network management, and even different domains may provide information to the same object, a server. Since the information provided by different domains is not always identical, a user's preferred function needs to be determined differently for each accessed source. The source may be information stored in the external device 20 or information that may be provided by a particular function of the external device 200. That is, a user's preferred function may be determined differently depending on a supplier of the accessed information or a type of information provided after access.

The function 201 is performed by the display apparatus 10 as a user selects a menu item of a GUI to use the function 201. The function 201 may be any function which the display apparatus 10 may provide to a user including an application executable by the display apparatus 10, a channel viewed by a user, setting for brightness of a screen, picture quality, etc.

The preference 203 is a figure stored by being increased or decreased as a user uses the function 201. The preference 203 increases if a user uses the function 201 more or more frequently, and decreases if a user does not use the function 201 for a certain period. An increase and decrease of the preference 203 may be used to determine whether a user prefers the function 201.

A usage time 205 is information on a time when a user commences a usage of the function 201 and on a time when he/she ends the usage thereof. The usage time 205 may include information on year/month/date as well as hour/minute/second.

According to another exemplary embodiment, the information stored in the storage 105 may further include various types of information relating to user information for identifying a user, the number of usage of the function 201, a period during which the function 201 was not used, a minimum time during which the function 201 may be deemed to have been used, setting of the function 201, a communication means for connection, a type of external device, a model name, whether the external device is a particular type, access time and usage of the function 201.

As an example of the user information for identifying a user, if there is a plurality of users using the display apparatus 10, an identification code may be used to identify each user. The storage 105 may additionally store information on a user's age, gender, etc. corresponding to each identification code. As the identification code is used, each user may use the function 201 and the preference 203 may increase or decrease accordingly. Even if a plurality of users uses the same display apparatus 10, a preferred function according to the connected external device 200 may vary depending on each user, and thus a GUI displayed may be different per user.

The storage 105 may further store information on the communication means for connection. The preferred function may be determined depending on the type of the communication means stored as above. The user's preferred function may vary depending on whether the communication means is wired or wireless, or performs RF communication or Bluetooth communication.

The storage 105 may further store information on a type of the connected external device 200. The type of the external device 200 may be a type of data stored by the external device 200 which is an image device or audio device, or a type of the external device 200 itself which is a set-top box, mobile device or server. The controller 103 may determine a user's preferred function according to a type of the connected external device 200.

The storage 105 may further store information on a model name of the external device 200. Even if the external devices 200 are the same type, a user may use a different function 201 of the display apparatus 10 according to the external device 200 in a different model name. For example, when one of USBs is connected to the display apparatus 10 for usage, a user may change a setting of the display apparatus 10 while watching a drama in the USB, and may use an image editing function when he/she connects and uses another USB.

The storage 105 may further store information on whether the external device 200 is a particular type. Whether the external device 200 is a particular type may be determined by a serial number stored in the external device 200. For example, if a plurality of users connects smart phones of the same model to the display apparatus 10, the preferred function 201 may vary depending on the particular smart phone connected to the display apparatus 10 and thus information on whether the external device 200 is a particular type needs to be further stored even if the external devices 200 are of the same type and same model name.

The storage 105 may further store information on access time during which the external device 200 is connected to the display apparatus 10. Depending on the length of the connection time of the external device 200, the function 201 used by a user while the external device 200 is connected to the display apparatus 10 may vary. The function 201 used by a user after the external device is disconnected from the display apparatus 10 may be also one of user's preferred functions according to the external device 200.

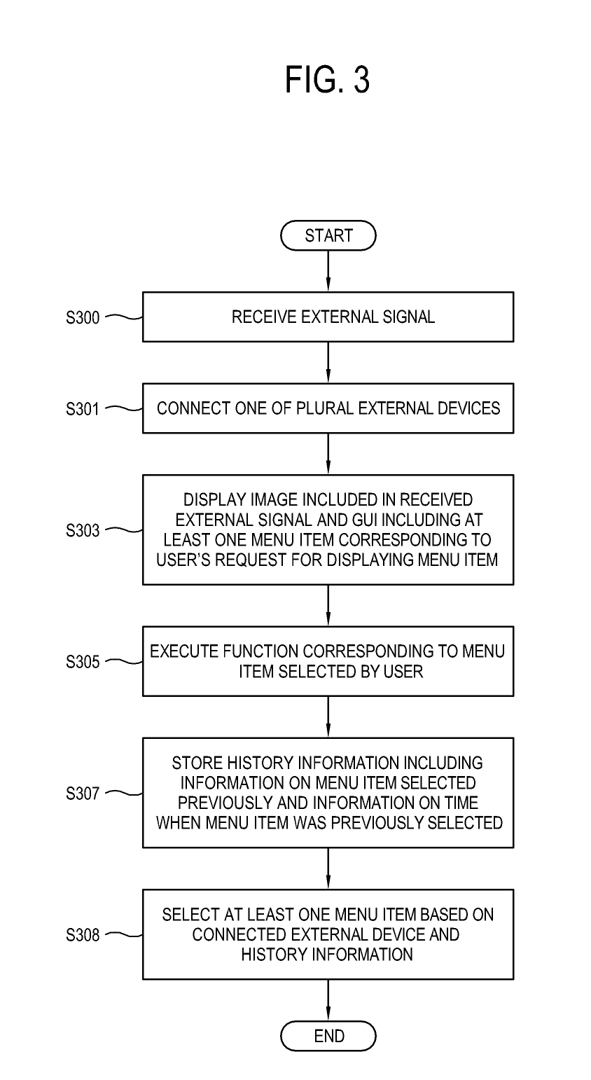

FIG. 3 is a flowchart showing operations of the display apparatus 10 according to an exemplary embodiment. At operation S300, the signal receiver 100 receives an external signal. At operation S301, the display apparatus 10 is connected to one of the plurality of external devices through the interface 107. At operation S303, the controller 103 displays in the display 101 an image included in the received external signal and a GUI including at least one menu item corresponding to a user's request for displaying the menu item. At operation S305, the controller 103 executes a function corresponding to the menu item selected by a user. At operation S307, the controller 103 stores history information including information on the menu item selected previously and information on the connected external device. At operation S308, the controller 103 selects at least one menu item based on the connected external device, and the history information.

The signal receiver 100 receives the external signal (S300) and provides the signal to the signal processor 111. The signal processor 111 processes the provided signal, and displays in the display 101 an image based on the processed signal by control of the controller 103.

The interface 107 is connected to one of the plurality of external devices connectable thereto by a user's selection (S301). The interface 107 may access an external source rather than the external device through the communicator as described above.

If a user makes a request for displaying a menu item while in connection with the external device, the image included in the external signal and a GUI including at least one menu item are displayed together in the display 101 by control of the controller 103 (S303).

A user may select the menu item of the GUI to use a function of the display apparatus 101, and the controller 103 executes the function corresponding to the selected menu item by a user's selection of the menu item (S305).

Then, history information including information on the menu item previously selected by a user and information on the time when the menu item was previously selected is stored in the storage 105 (S307). As shown in FIG. 2, the external device 200, the function 201 used, the preference 203 of the function 201 and the time 205 when the function 201 was used may be stored in the storage 105.

Then, the controller 103 selects at least one menu item based on the connected external device and the history information stored in the storage 105 (S308). The selected menu item may correspond to the preferred function which has been determined to be a user's preferred function. That is, the controller 103 determines the function 201 preferred by a user according to the connected external device to be a user's preferred function and selects the menu item corresponding to the preferred function as determined above (S307). The user's preferred function may be determined based on the preference 203 of the function 201 according to the connected external device. The method of determining the preferred function based on the preference 203 will be described later.

Corresponding to a user's future request for displaying a menu item, the controller 103 may display in the display 101 a GUI including a menu item selected on the basis of the connected external device and the history information. That is, if the external device is connected and a request for displaying a menu item is made, a menu item corresponding to a user's preferred function according to the particular connected external device is provided for a user to easily select the menu item, and thus, a user may select the displayed menu item and use a relevant function. In another exemplary embodiment, the interface 107 may include a communicator and may communicate with the external device 200 to access one of a plurality of sources supplying information. According to this exemplary embodiment, the controller 103 controls the communicator of the interface 107 and accesses at least one source (S301). If a function corresponding to a menu item selected by a user is executed while a user receives information from the accessed source (S305), history information on the function used by a user and the accessed source is stored (S307). Based on the connected external device and the stored history information, a user's preferred function according to the accessed source is determined and a menu item corresponding to the preferred function is selected (S308). If a user requests for displaying a menu item, the controller 103 displays a GUI including the menu item corresponding to the user's preferred function (S303). The user's preferred function may be determined according to the source supplying information rather than according to the connected external device 200. Even if each of sources supplying information in a network may be different, the connected external device 200 may be the same or of the same type and thus the preferred function may vary depending on the accessed source.

According to another exemplary embodiment, the controller 103 may always display in the display 101 a menu item corresponding to a user's preferred function according to the connected external device 200 even without a user's manipulation. Otherwise, the controller 103 may automatically execute a preferred function without separately displaying a GUI.

According to another exemplary embodiment, the display apparatus 10 in which a preferred function has been already determined may be provided to a user. After a function usage history of other plural users is analyzed, a prediction model which predicts a preferred function of a user who will use the display apparatus 10 is created. At the beginning of usage, the display apparatus 10 may display a menu item that has been selected corresponding to a predetermined function which has been determined by using the prediction model. The preferred function which has been determined by the prediction model is not necessarily identical to a user's preferred function, but it may be fairly identical thereto since it has been based on the usage history of the plural users. If a user uses the display apparatus 10 for a considerable period thereafter, the preferred function is updated to a function that a user actually prefers.

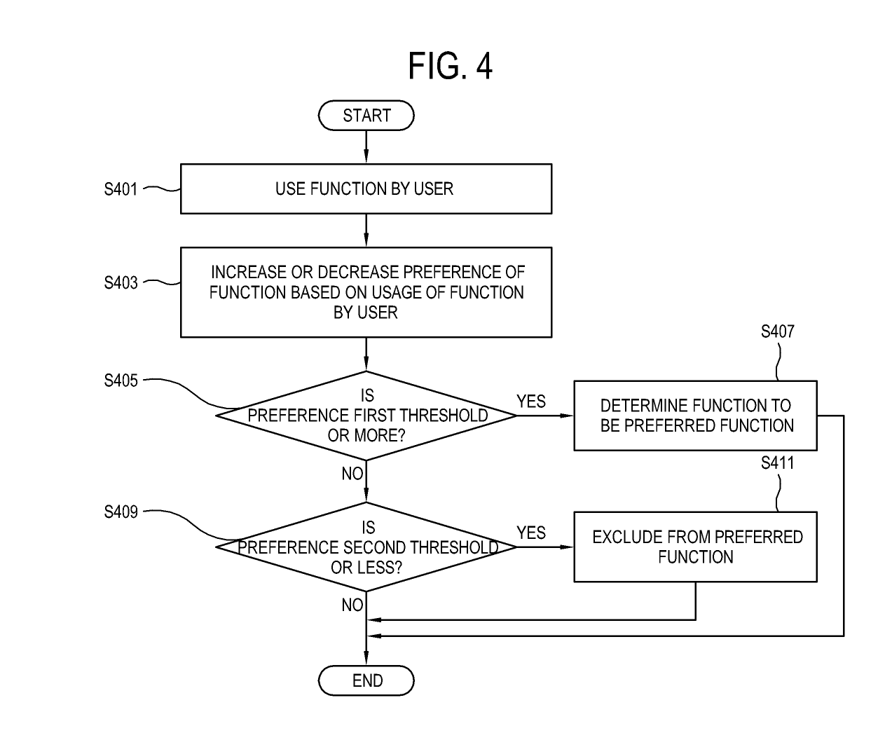

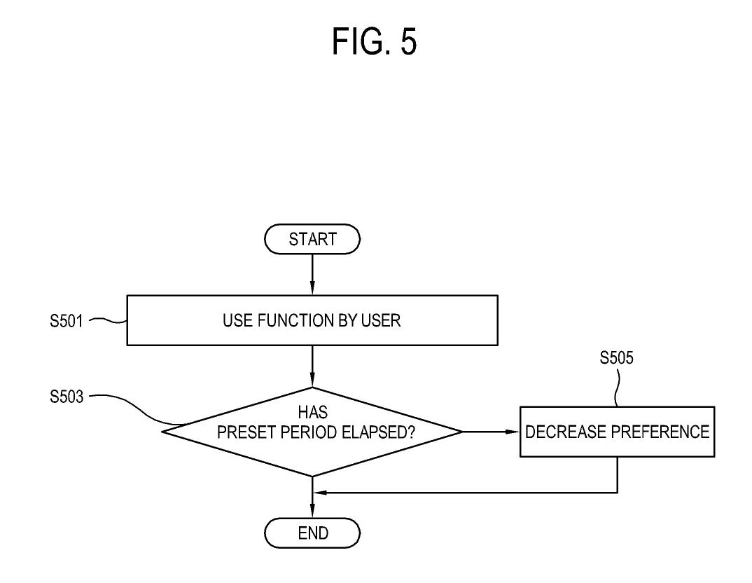

FIG. 4 is a flowchart showing operations of determining a preferred function in accordance with an increase and decrease of the preference 203 according to an exemplary embodiment. FIG. 5 is a flowchart showing operations of decreasing a preference of the function 201. The preference 203 of the function 201 may increase or decrease as a user uses the function 201. The preference 203 is a virtual figure for determining whether a user prefers the function 201 and is stored in the storage 105. If the preference 203 increases beyond a preset first threshold, it means a user uses the function 201 frequently or a lot and thus the function 201 needs to be determined to be a preferred function. If the preference 203 decreases and becomes less than a preset second threshold, it means a user does not frequently use the function 201 anymore and thus the function 201 may be excluded from the preferred function.

At operation S401, a user uses the function 201. At operation S403, the controller 103 increases or decreases the preference 203 of the function 201 according to the connected external device 200 based on the usage of the function 201 by a user. At operation S405, the controller 103 determines whether the preference 203 of the function 201 is the first threshold or more. If it is determined that the preference 203 of the function 201 is the first threshold or more, the controller 103 determines the function 201 to be the preferred function at operation S407. If the preference 203 of the function 201 is not the first threshold or more, the controller 103 determines whether the preference 203 of the function 201 is the second threshold or more at operation S409. If the preference 203 of the function 201 is the second threshold or less, the controller 103 excludes the function 201 from the preferred function at operation S411.

If a user uses at least one function 201 selected by him/her from a plurality of functions which may be provided by the display apparatus 10 (S401), information 20 on the function 201 used by a user and the connected external device 200 is stored in the storage 105. The information 20 has been described above.

Based on the time 205, during which a user used the function 201, the controller 103 increases or decreases the preference 203 of the function 201 according to the connected external device 200 (S403). More specifically, the controller 103 increases the preference 203 whenever a user uses the function 201. Determining on whether a user used the function 201 may be made if a user accesses the function 201, or used the function 201 corresponding to the selection of the menu item, or according to another exemplary embodiment, if a user used the function 201 for predetermined time or more. The predetermined time which may be a basis for determining that a user used the function 201 may vary by each function 201. Also, the increase or decrease in the preference 203 may vary by each function 201.

FIG. 5 is a flowchart showing operations of decreasing the preference 203 of the function 201. After a user used the function 201 (S501), the controller 103 determines that a predetermined period has elapsed (S503). If the predetermined period elapsed, the preference 203 of the function 201 according to the connected external device 200 is decreased (S505). Regardless of whether the function 201 was used for the preset period, the controller 103 decreases the preference 203 if the preset period elapses.

In another exemplary embodiment, if the function 201 was used for a preset period, the controller 103 may initialize the calculation of the preset period and may elect not to decrease the preference 203. The preset period which is used as a basis for decreasing the preference 203 may be set differently by each function 201, and relevant information may be stored in the storage 105.

In another exemplary embodiment, the controller 103 additionally increases or decreases the preference 203 of the function 201 according to the connected external device 200, based on a frequency of using the function 201 by a user. More specifically, if the function 201 is used for a predetermined frequency or more during a preset period, the controller 103 may additionally increase the preference 203 of the function 201 whenever the function 201 is used. Also, if the preference 203 of the function 201 is continuously decreased without an increase, the controller 103 may additionally decrease the preference 203 of the function 201.

In another exemplary embodiment, the controller 103 may vary a degree of increase or decrease of the preference 203 depending on whether the function 201 is a preferred function when determining the preference 203 of the function 201. If the function 201 used is a preferred function, the controller 103 may increase the preference 203 more or decrease it less than the case where the function 201 is not the preferred function. On the contrary, if the function 201 used is not the preferred function, the controller 103 may increase the preference 203 more or decrease it less than the case where the function 201 is the preferred function.

To determine whether the function 201 is the preferred function, the controller 103 determines whether the preference 203 of the function 201 is the first threshold or more (S405). The function 201 whose preference 203 according to the connected external device 200 is the first threshold or more means that a user prefers to use the function 201 while in connection with the external device 200. Thus, if the preference 203 of the function 201 is the first threshold or more, the controller 103 determines the function 201 to be a user's preferred function according to the connected external device 200 (S407). If the function 201 is already the user's preferred function, whether the preference 203 of the function 201 is the first threshold or more is not determined.

If the preference 203 of the function 201 is not the first threshold or more, the controller 103 determines whether the preference 203 of the function 201 is the second threshold or less (S409). The function 201 whose preference 203 according to the connected external device 200 is the second threshold or less means that a user does not prefer to use the function 201 anymore while in connection with the external device 200. Thus, if the preference 203 of the function 201 is the second threshold or less, the controller 103 excludes the function 201 from the user's preferred function (S411). If the function 201 is not already the user's preferred function, whether the preference 203 of the function 201 is the second threshold or less is not determined. If the function is the preferred function, and if the preference 203 of the function 201 is decreased to the second threshold or less, the function 201 may be excluded from the preferred function and a corresponding menu item may not be displayed anymore. The second threshold may be equal to the first threshold, but may also be lower than the first threshold to prevent a function selected as the preferred function from being easily excluded from the preferred function.

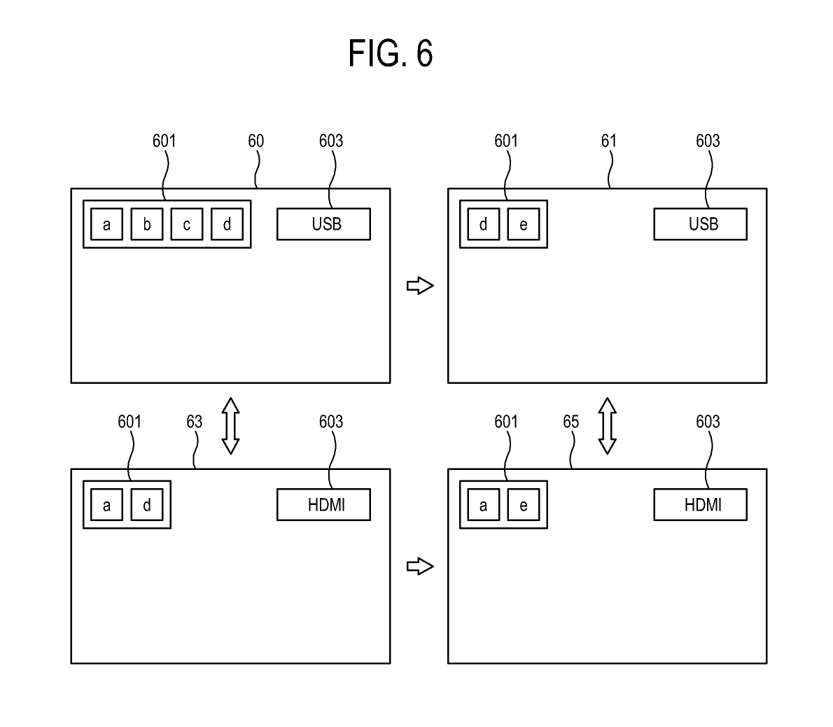

FIG. 6 illustrates an example of the display 101 which displays a GUI according to an exemplary embodiment. A GUI including at least one menu item 601 corresponding to the preferred function according to the connected external device 200 and [an item of] the connected external device 603 is displayed in the display 101. The display 101 displays a GUI 60 including a menu item 601 a, b, c and d corresponding to a function preferred by a user, and an item 603 corresponding to the connected external device while in connection with a USB. The display 101 displays a GUI 61 including a menu item 601 a and b corresponding to a function preferred by a user, and an item 603 corresponding to the connected external device while in connection with a HDMI. The menu item 601 may be generated and displayed by the display apparatus 10 on its own or may be provided and displayed by the connected external device 60. If the connected external device 603 displays the menu item 601 corresponding to the preferred function, the controller 103 may transmit to the external device 603 the usage history stored in the storage 105 through the interface 107 to cause the external device 603 to re-arrange the menu item 601 to be provided. The GUIs 60 and 61 including at least one menu item 601 corresponding to a user's preferred function according to the external device 200 and the external device 603 currently connected may be displayed in the display 101 by a user's input of a control command. Otherwise, the GUIs 60 and 61 including at least one menu item 601 corresponding to a user's preferred function according to the external device 200 and the external device 603 currently connected may be automatically displayed in the display 101 without a user's input of a control command. The particular external device 200 may be the external device 603 currently connected, or at a user's selection may be another particular external device 200 rather than the external device 603 currently connected. In such case, the menu item 601 corresponding to the preferred function according to the particular external device 200 selected by a user rather than corresponding to the preferred function according to the external device 603 currently connected is displayed. The layout and explanation on the displayed GUIs 60 and 61 are just an example, and may otherwise be variously displayed depending on the method of achievement.

If the GUIs 60 and 61 are displayed and a user further uses the display apparatus 10 for a certain period, the display 101 displays GUIs 63 and 65 including a changed user's preferred function according to the connected external device 603.

The GUIs 60 and 61 and the GUIs 63 and 65 which are displayed by the display 101 may be those displayed for different users. This is because even if two display apparatuses 10 store the same preferred function at the beginning, the preferred function according to the connected external device 603 may be changed by usage for a long time. As a user continuously uses the display apparatus 10, the preferred function displayed in a screen will be those that a user truly prefers.

In another exemplary embodiment, the menu item 601 corresponding to the preferred function is not included in the GUI to be displayed in the display 101, and instead the preferred function according to a particular external device may be directly executed in response to a connection of such particular external device. For example, if a user has mainly viewed an image stored in a USB after connecting the USB to a television, the image of the USB may be displayed by the display 101 whenever a user connects the USB to the television. According to this exemplary embodiment, the function 201 that is executed after the external device 200 is connected may vary depending on a user using the display apparatus 100, or depending on a period during which a user used the display apparatus 10.

In another exemplary embodiment, a GUI including a menu item corresponding to a preferred function according to an accessed source, and an accessed source may be displayed in the display 101. The source may be the domain, information stored in the external device 200 or information which may be provided by a particular function of the external device 200. If the display apparatus 10 accesses a particular source by a user's control command, the source may provide information and a menu item for providing information and function. If the display apparatus 10 transmits information on a preferred function to the source, the source may display a GUI including a menu item corresponding to a user's preferred function. The GUI may be displayed by a user's control command, or may be automatically displayed once the display apparatus 10 accesses the source as described above.

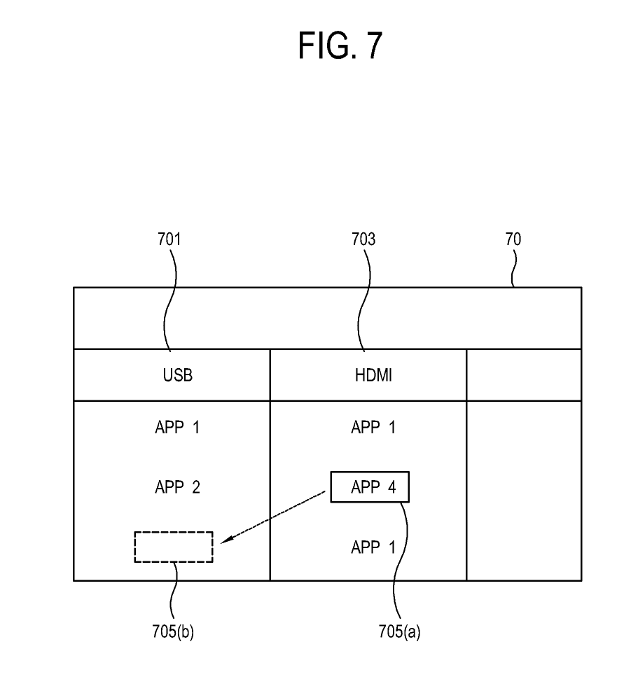

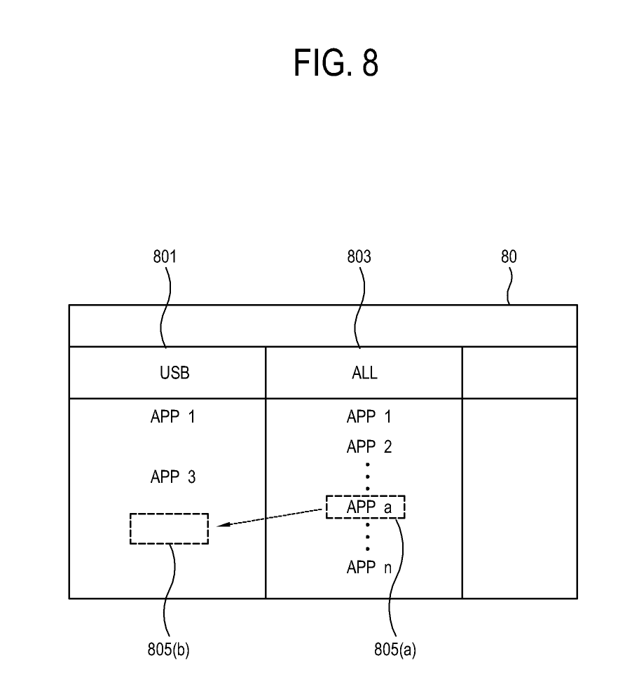

FIGS. 7 and 8 illustrate an example of GUIs 70 and 80 which are displayed for a user to edit a preferred function according to an exemplary embodiment. Determining a user's preferred function by the controller 103 based on the preference 203 may be convenient, but the user's preferred function determined by the controller 103 may be inconsistent with the function 201 that a user actually prefers and desires to use without difficulty. To prevent such inconsistency, the GUIs 70 and 80 for editing a preferred function are provided for a user to determine the function 201 as the preferred function on his/her own, to exclude un-preferred function 201 from the preferred function, and change or add the name of the external device 200.

FIG. 7 illustrates an example of an editing GUI 70 for editing a preferred function according to an exemplary embodiment. The GUI 70 is displayed for a user to change the preferred function according to a first external device 701 to a preferred function according to a second external device 703. The editing GUI 70 includes menu items corresponding to preferred functions according to the first and second external devices 701 and 703. To determine an APP 1, which is one of preferred functions of the second external device 703, to be a preferred function of the first external device 701, a user may move a menu item 705(a) corresponding to the APP 1 to a blank space 705(b) of the first external device 701. The movement may be performed by simple and intuitive manipulation such as drag-and-drop or click. If the movement is completed, the APP 1 is excluded from the preferred function according to the second external device 703 and is determined to be the preferred function according to the first external device 701. It is also available to copy and paste the preferred function from the second external device 703 to the first external device 701 depending on the exemplary embodiment. The foregoing description and the GUI in FIG. 7 are just an example, and there may be various examples of GUIs that are displayed to move or copy at least one preferred function.

FIG. 8 illustrates an example of a preferred function editing GUI 80 which is displayed for a user to determine a preferred function by himself/herself among a plurality of functions that the display apparatus 10 may perform according to an exemplary embodiment. The GUI 80 includes a menu item corresponding to a preferred function according to a particular external device 801 and an all functions 803. To determine the APP 1, which is one of the all functions 803, to be a preferred function according to the particular external device 801, a user may move a menu item 805(a) of the APP 1 to a blank space 805(b) of the particular external device 801. The movement may be performed by simple and intuitive manipulation such as drag-and-drop or click. If the movement is completed, the moved APP 1 is determined to be the preferred function according to the particular external device 801. Excluding the preferred function according to the particular external device 801 is also available depending on the exemplary embodiment. The foregoing description and the GUI in FIG. 8 are just an example, and there may be various examples of GUIs that are displayed to determine at least one preferred function or to exclude a function from the preferred function.

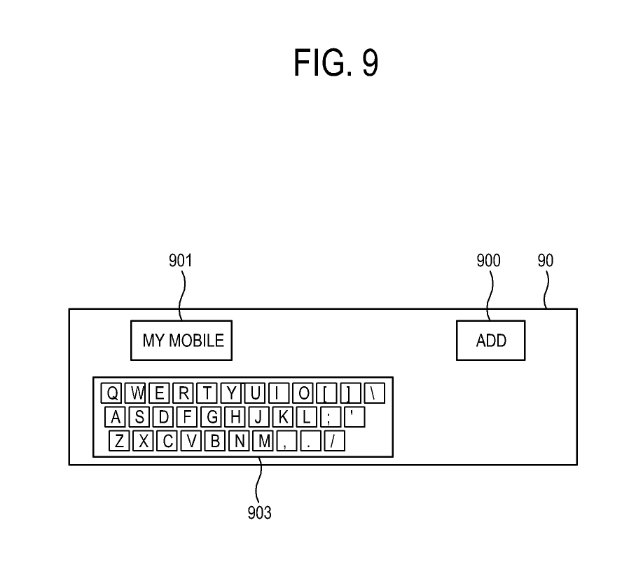

FIG. 9 illustrates an example of editing GUI 90 which is displayed for a user to edit a name of the external device 200 or to add the external device 200 according to an exemplary embodiment. The GUI 90 includes an add button 900, the external device 200 and a keyboard 903 for inputting a name of the external device 200. A user may need a function to change a name of the external device 200 or add a new external device 200 according to his/her preference. If a user inputs a control command to the display apparatus 10 to change a name of the external device 200, the editing GUI 90 is displayed to provide a user with a function of editing the name of the external device 200.

A user may change the name of the connected external device 200 by manipulating the displayed GUI 90. A user may directly input the name by using the keyboard 903 provided through the GUI 90 or may select the name from preset items.

A user may add a new external device 200 by selecting the add button 900. The new external device 200 may be an external device 200 whose communication means or model name is different from that of the existing external device 200. A user may select the add button 900 and input a name of the connected external device 200. If the same external device 200 is connected to the display apparatus 20 in the future, the name determined by a user will be displayed.

In another exemplary embodiment, a user may change a name of at least one of the plurality of external devices 200 connected to the display apparatus 10.

The foregoing description and the editing GUI 90 in FIG. 9 are just an example. There may be various examples of editing GUI 90 that is displayed for a user to change the name of the connected external device 901 or to add the new external device 901.

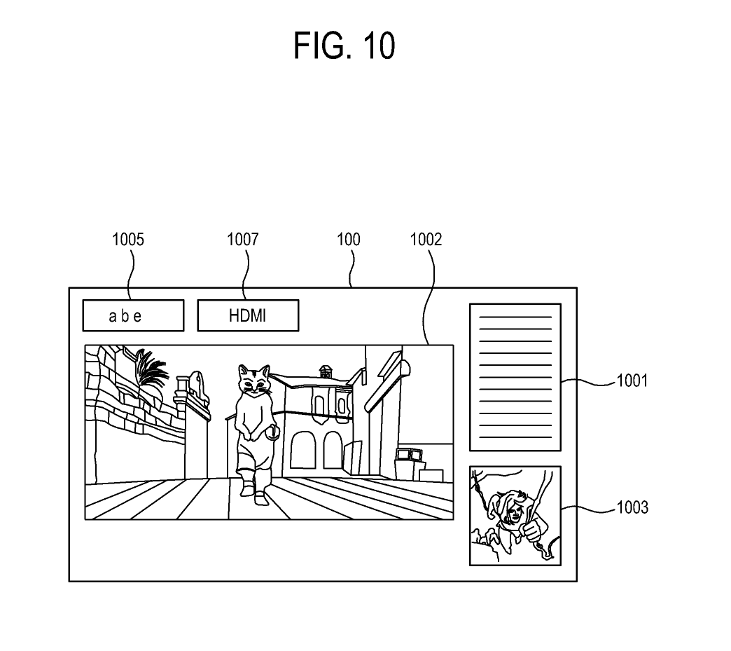

FIG. 10 illustrates an example of the display apparatus 10 in which an image content 1002 selected by a user and functions 1001 and 1003 provided to a user are displayed in the display 100. The display apparatus 10 may display an image content 1002 of a plurality of images received by the display apparatus 10 in accordance with a user's selection. The display apparatus 10 may, together with the image content 1002, display a GUI including a plurality of functions 1001 and 1003 provided to a user, a menu item 1005 corresponding to a preferred function and the connected external device 1007.

As described above, the display apparatus 10 may receive an image signal from the exterior and process the image signal, and display the image content 1002 based on the processed image signal. The external apparatus means all types of devices that may provide an image signal to the display apparatus 10 including a broadcasting station transmitting a broadcast signal, a network server connected in a wireless or wired manner or an external electronic device such as a computer. A user may select the image content 1002 from a plurality of image contents that may be displayed by the display apparatus 10, and view the image content 1002. The selection may be a selection of a channel to which a frequency of a broadcasting station is allocated or a selection of an external device connected to the display apparatus 10.

The display apparatus 10 may, together with the image contents 1002, display in the display 101 all of functions that the display apparatus 10 may provide including image related information 1001 such as subtitles, explanation of the image, picture in picture (PIP) 1003, screen adjustment, channel reservation and various applications.

The display apparatus 10 may display the menu item 1005 corresponding to a user's preferred function according to the external device 1007 connected by a user's selection while displaying the image content 1002 after being connected with the external device 200. The menu item 1005 corresponding to the preferred function may be displayed always even without a user's manipulation, and the user's preferred function according to the connected external device 1007 may be executed without displaying the menu item 1005, as described above.

According to another exemplary embodiment, FIG. 10 may be a screen 100 shown when the display apparatus 10 accesses a source. The screen 100 may include the image content 1002, the accessed source 1007, the menu item 1005 corresponding to a user's preferred function according to the accessed source 1007 and various functions 1001 and 1003.

The accessed source may be a particular domain or available information as described above, and whether any source is accessed may be displayed in the screen 100.

The screen 100 may be provided by the accessed source 1007, or the source 1007 may provide the display apparatus 10 only with the image content 1002 and/or the functions 1001 and 1003. That is, a user may input a command to receive information 1001 related to the image content 1002 from the accessed source and display the information 1001 as the PIP 1003, or to receive another screen relating to the image content 1002 and to display the screen as the PIP 1003 while using the display apparatus 10. If a user uses the foregoing function while in access to the particular source 1007, the function may be determined to be the preferred function. If a user accesses the particular source 1007 again, he/she may receive the menu item 100 corresponding to the preferred function from the accessed source 1007, or as soon as a user accesses the particular source 1007, the functions 1001 and 1003 may be directly executed.

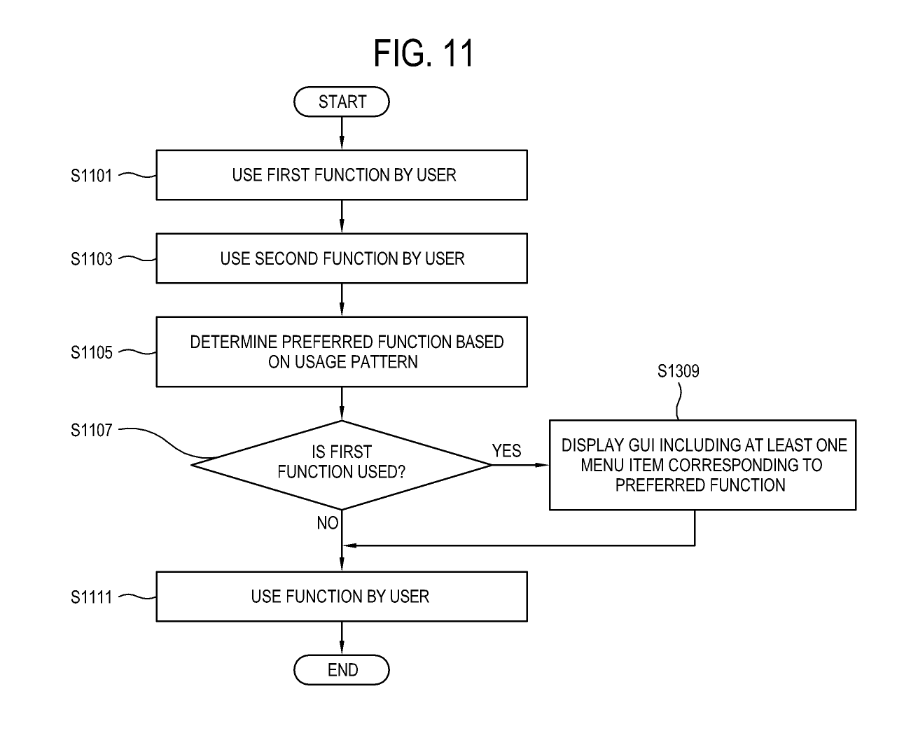

FIG. 11 is a flowchart showing operations of determining and displaying a preferred function based on a user's function usage pattern according to an exemplary embodiment. The preferred function may be determined on the basis of a user's usage pattern of the function 201 as well as on the basis of a usage of the function 201 by a user. The controller 103 may determine the preferred function depending on a user's function usage pattern by analyzing how a user has used the function 201. If the preferred function depending a user's usage pattern of a particular pattern is decided, the controller 103 may provide a user with a GUI asking a user whether to use the determined preferred function whenever the same function usage pattern is present. Below, exemplary embodiments for determining a preferred function based on a user's usage pattern and for displaying the preferred function will be described with reference to a screen in FIG. 10 and flowchart in FIG. 11.

FIG. 11 is a flowchart showing operations of determining and displaying a preferred function based on a usage pattern of using a first function and then using a second function according to an exemplary embodiment. At operation 51101, a user uses the first function. At operation S1103, a user uses the second function. At operation 51105, the controller 103 determines the preferred function based on a user's function usage pattern. After the preferred function is determined, the controller 103 determines whether a user uses the first function at operation 51107. If the controller 103 determines that a user uses the first function, the controller 103 displays in the display 101 a GUI including the menu item 1005 corresponding to the user's preferred function at operation 51309. Lastly, at operation 51111, a user selects and uses the function 201.

The first and second functions are voluntary functions 201 which a user has selected from a plurality of functions that the display apparatus 10 may provide to a user. If the first function is used and then the second function is used, the display apparatus 10 recognizes a user's linked function usage as a function usage pattern and determines a user's preferred function based on the foregoing. The preferred function may be the second function following the first function used by a user. The preferred function may be determined based on an increase/decrease of the preference 203 as described above.

If a user uses the function 201 after the preferred function is determined, the controller 103 determines whether the function 201 used by a user is the first function (S1109).

If the controller 103 determines that a user has used the first function, it displays in the display 101 the GUI including the menu item 1005 corresponding to the determined preferred function by a user's manipulation (S1109).

In another exemplary embodiment, if a user uses the first function, the GUI including the menu item 1005 corresponding to the preferred function may be directly displayed in the display 101, or the determined preferred function may be directly executed.

In another exemplary embodiment, after the external device 200 is disconnected from the display apparatus 10, the preferred function may be determined according to a user's usage pattern of using the function. If a function used by a user after the external device is disconnected from the display apparatus 10 is frequently used by a user as well as the function 201 used while the external device 200 is connected to the display apparatus 10, such function may be deemed a preferred function. For example, there may be exemplary embodiments in which a user changes a setting of the display apparatus 10 after an HDMI is disconnected, or a user receives a file from a computer and uses the file through a particular application after disconnecting the computer.

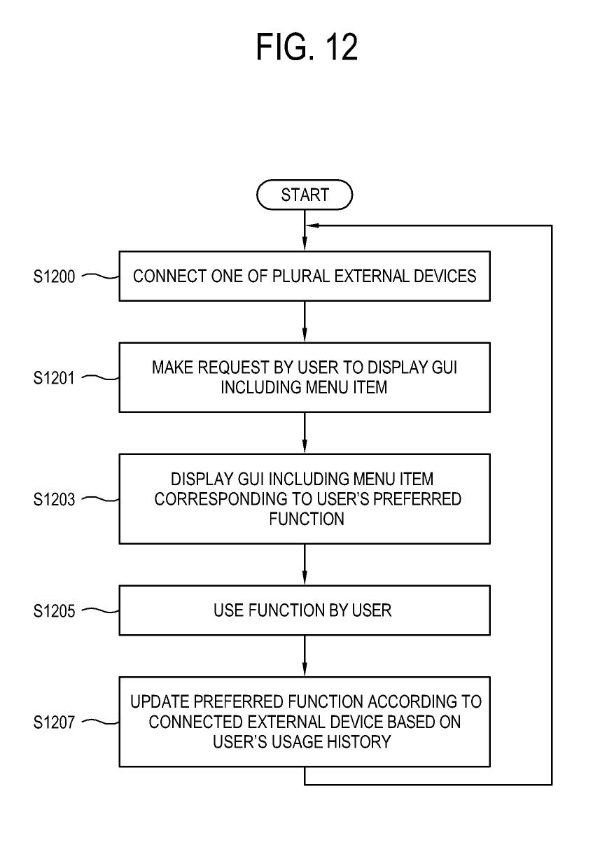

FIG. 12 is a flowchart showing operations of displaying and updating a user's preferred function according to an exemplary embodiment. At operation S1200, the display apparatus 10 is connected to one of the plurality of external devices through the interface 107. At operation S1201, a request is made to display the GUI including the menu item corresponding to at least one of the plurality of functions. At operation S1203, the controller 103 displays in the display 101 the GUI including the menu item corresponding to the user's preferred function according to the connected external device 200. At operation S1205, a user uses at least one of the functions provided by the display apparatus 10. The controller 103 updates the preferred function according to the connected external device 200 based on a user's usage history of functions.

The display apparatus 10 may be connected to one of the plurality of external devices through the interface 107 (S1200). The plurality of external devices means all of external devices which may be connected to the display apparatus 10 through USB, HDMI, LAN, etc. as described above.

The request for displaying the GUI (S1201) may be a user's input of a control command, or may be a control command of the controller 103 to automatically display the GUI according to an algorithm.

Corresponding to the request for displaying the GUI (S1201), the controller 103 displays in the display 101 the GUI including the menu item corresponding to a user's preferred function according to the connected external device 200, and an item corresponding to the connected external device 200 (S1203). The GUI displayed as above has been described in detail in FIGS. 6 and 10.

If a user uses the function 201 of the display apparatus 10 (S1205), the controller 103 updates the preferred function according to the connected external device 200 based on usage history regarding a user's usage of the function 201 (S1207). As described above, the preferred function may be updated by determining a function to be the preferred function or excluding a function from the preferred function as the preference 203 of the function 201 increases or decrease and depending on whether the preference 203 is more than a threshold value.

Corresponding to the request for displaying the GUI (S1201), the GUI including the menu item corresponding to the newly updated preferred function may be displayed (S1203). If the function 201 is determined to be the preferred function, the corresponding menu item is included in the GUI. With respect to a function excluded from the preferred function, the corresponding menu item is removed from the GUI.

As the preferred function is updated based on the usage history (S1207), the more a user uses the display apparatus 10, the easier it would be for a user to use the menu item corresponding to the preferred function.

As described, the display apparatus and control method thereof according to exemplary embodiments analyzes and provides a user's preferred function in a current timeline to thereby improve usability of a user using the display apparatus.

Although a few exemplary embodiments have been shown and described, it will be appreciated by those skilled in the art that changes may be made in these exemplary embodiments without departing from the spirit and scope defined in the appended claims and their equivalents.

What is claimed is:

1. A display apparatus comprising:
a display;
an interface configured to connect to an external device;
a storage; and
a controller configured to:
while connected with the external device, control the display to display a first graphical user interface (GUI) comprising a plurality of menu items corresponding to a plurality of functions, and perform a function corresponding to a menu item selected by a user from among the plurality of menu items,
control the storage to store history information comprising information associated with the menu item and information on the external device connected through the interface when the menu item is selected, and
in response to receiving a request for a GUI, control the display to display a second GUI comprising at least one menu item selected based on the history information and the external device connected through the interface when the request for the GUI is received.

2. The display apparatus according to claim 1, wherein the controller, based on the history information, is further configured to increase or decrease a preference of at least one function, determine a function having the preference greater than or equal to a first threshold to be a preferred function of the user, and control the display to display the second GUI comprising at least one menu item corresponding to the preferred function.

3. The display apparatus according to claim 2, wherein the controller is further configured to exclude a function having the preference equal to or less than a second threshold from the preferred function.

4. The display apparatus according to claim 2, wherein the controller is further configured to additionally increase or decrease the preference of the at least one function based on a frequency of the user selecting a menu item corresponding to the at least one function.

5. The display apparatus according to claim 2, wherein the controller is further configured to increase or decrease the preference of the at least one function in a manner based on whether the at least one function comprises the preferred function.

6. The display apparatus according to claim 1, wherein the controller is further configured to determine at least one function among the plurality of functions to be a preferred function of the user based on a function usage pattern of the user, and control the display to display a third GUI comprising at least one menu item corresponding to the preferred function based on the function usage pattern in response to the function usage pattern is being detected.

7. The display apparatus according to claim 6, wherein the function usage pattern comprises a use of a first function of the plurality of functions, followed by a use of a second function of the plurality of functions.

8. The display apparatus according to claim 6, wherein the function usage pattern comprises a use of at least one function within a preset time after the external device is disconnected.

9. The display apparatus according to claim 2, wherein the controller is further configured to control the display to display a fourth GUI for a user to edit the preferred function.

10. The display apparatus according to claim 1, wherein the second GUI is received from the connected external device.

11. A control method of a display apparatus comprising:
connecting to an external device through an interface;
while connected with the external device, displaying a first graphical user interface (GUI) comprising a plurality of menu items corresponding to a plurality of functions, and performing a function corresponding to a menu item selected by a user from among the plurality of menu items;
storing history information comprising information associated with the menu item and information on the external device connected through the interface when the menu item is selected; and
in response to receiving a request for a GUI, displaying a second GUI comprising at least one menu item selected based on the history information and the external device connected through the interface when the request for the GUI is received.

12. The control method according to claim 11, wherein the displaying the second GUI comprises:
increasing or decreasing a preference of at least one function based on the history information;
determining a function having preference greater than or equal to a first threshold to be a preferred function of the user; and
displaying a second GUI comprising at least one menu item corresponding to the preferred function according to the preferred function.

13. The control method according to claim 12, wherein the displaying the second GUI further comprises excluding a function having preference less than or equal to a second threshold from the preferred function.

14. The control method according to claim 12, wherein the increasing or decreasing the preference of the at least one function comprises additionally increasing or decreasing the preference of the at least one function based on a frequency of the user selecting a menu item corresponding to the at least one function.

15. The control method according to claim 12, wherein the increasing or decreasing the preference comprises increasing or decreasing the preference of the at least one function in a manner based on whether the at least one function comprises the preferred function.

16. The control method according to claim 11, further comprising:
determining at least one function among the plurality of functions to be a preferred function of the user based on a function usage pattern of the user; and
displaying a third GUI comprising a at least one menu item corresponding to the preferred function based on the function usage pattern in response to the function usage pattern is being detected.

17. The control method according to claim 16, wherein the function usage pattern comprises a use of a first function of the plurality of functions followed by a use of a second function of the plurality of functions.

18. The control method according to claim 16, wherein the function usage pattern comprises a use of at least one function within a preset time after the external devices is disconnected.

19. The control method according to claim 12, further comprising displaying a fourth GUI for a user to edit the preferred function.

20. The control method according to claim 11, wherein the displaying of the second GUI further comprises receiving the second GUI from the connected external device.
